(19) United States
(12) Patent Application Publication
(10) Pub. No.: US 2017/0116667 A1
(43) Pub. Date: Apr. 27, 2017

(54) APPARATUS AND METHOD FOR PROVIDING A VIRTUAL SHOPPING SPACE

(71) Applicant: Wal-Mart Stores, Inc., Bentonville, AR (US)

(72) Inventors: Donald R. High, Noel, MO (US); Chandrashekar Natarajan, San Ramon, CA (US); Dhaval Gat, Bangalore (IN)

(21) Appl. No.: 15/299,883

(22) Filed: Oct. 21, 2016

Related U.S. Application Data
(60) Provisional application No. 62/244,669, filed on Oct. 21, 2015.

(51) Int. Cl. G06Q 30/06; G06T 19/00

(52) U.S. Cl. CPC G06Q 30/0643; G06Q 30/0633; G06T 19/006; G06F 3/167

(57) ABSTRACT

Systems, apparatuses, and methods are provided herein for providing a virtual shopping space. In one embodiment, a system for providing a virtual shopping space comprises a projection display device, a motion tracking device, a control circuit coupled to the projection display device and the motion tracking device. The control circuit is configured to: cause the projection display device to project at least a portion of a virtual store into a physical space to a user, the virtual store comprising a plurality of interactive virtual items, modify the display of the at least the portion of the virtual store based on user motion detected by the motion tracking device, receive a user selection of an interactive virtual item in the virtual store, and submit, to an order fulfillment and shipment system, a purchase order for a real-world item, corresponding to the selected interactive virtual item in the virtual store.

### CROSS-REFERENCE TO RELATED APPLICATION

This application claims the benefit of U.S. Provisional Application No. 62/244,669, filed Oct. 21, 2015, which is incorporated herein by reference in its entirety.

### TECHNICAL FIELD

This invention relates generally to online commerce.

### BACKGROUND

Conventional online stores are generally designed to be displayed in a display screen and navigated with mouse and keyboard. Items in an online store are generally shown as two-dimensional pictures arranged in a grid.

### BRIEF DESCRIPTION OF THE DRAWINGS

Disclosed herein are embodiments of apparatuses and methods for providing a virtual shopping space. This description includes drawings, wherein:

FIG. 1 is a block diagram of a system in accordance with several embodiments.

FIG. 2 is a flow diagram of a method in accordance with several embodiments.

FIG. 3 is a block diagram of an overall system in accordance with several embodiments.

FIG. 4 is an illustration of customized store layouts in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for providing a virtual shopping space. A system for providing a virtual shopping space comprises a projection display device, a motion tracking device, a control circuit coupled to the projection display device and the motion tracking device. The control circuit is configured to: cause the projection display device to project at least a portion of a virtual store into a physical space to a user, the virtual store comprising a plurality of interactive virtual items, modify the display of the at least the portion of the virtual store based on user motion detected by the motion tracking device, receive a user selection of an interactive virtual item in the virtual store, and submit, to an order fulfillment and shipment system, a purchase order for a real-world item, corresponding to the selected interactive virtual item in the virtual store.

The present disclosure generally describes providing a virtual shopping space that offers an in-store shopping experience to customers through 3D projection virtual simulation. The virtual store may allow the customer to navigate through the store and interact with items for sales with motions in a physical space that corresponds to the projected virtual space. The virtual store may also be configured to allow customers to add items to a purchase list and submit payments within the virtual environment. In some embodiments, the virtual store may further provide “try-on” functions that allow a customer to virtually overlay products with the customer and/or customer's physical environment such as the customer's home prior to purchasing the product. The try-on function may be provided for products with a visual aesthetic factor such as apparels, jewelry, furniture, and home decoration, etc. User's actions in the virtual store may further be used for predictive analytics for targeted promotions and individualized recommendation.

The systems and methods described herein may allow customers to project a 3D virtual shopping space into their homes and/or other locations. For example, a small space (e.g. a booth) may be used to project various sections of a virtual store such that the user can experience a large store layout within a limited physical space. In some embodiments, items ordered through the virtual store may be picked up at specified locations and/or shipped to the customer. In some embodiments, sections of the virtual store may be leased out and managed by different entities.

In some embodiments, physical locations for accessing virtual stores may be set up in public areas, shopping centers, companies, university campuses, etc. Customers may use the projection display system in these access locations to interact with the virtual store and place orders for real-world items. At home, a customer may change the color, lighting, and showcase items every day in their home environment through the virtual store technology. The virtual store may also provide an intelligent personal shopper to customers that keep track of shopping habits and history to advise customers on purchases.

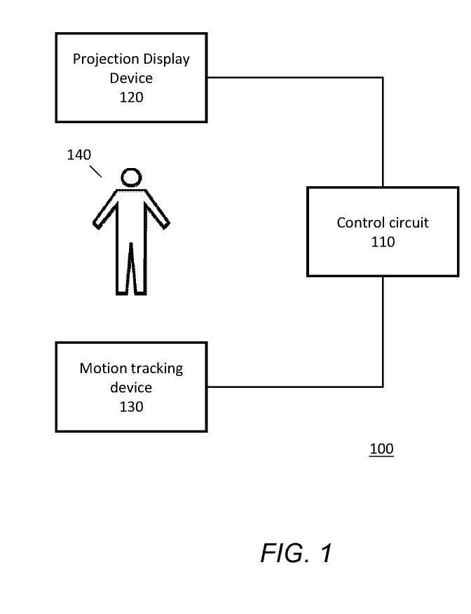

Referring now to FIG. 1, a system for providing a virtual store is shown. The system 100 includes a control circuit 110 coupled to a projection display device 120 and a motion tracking device for tracking the motions of a user 140.

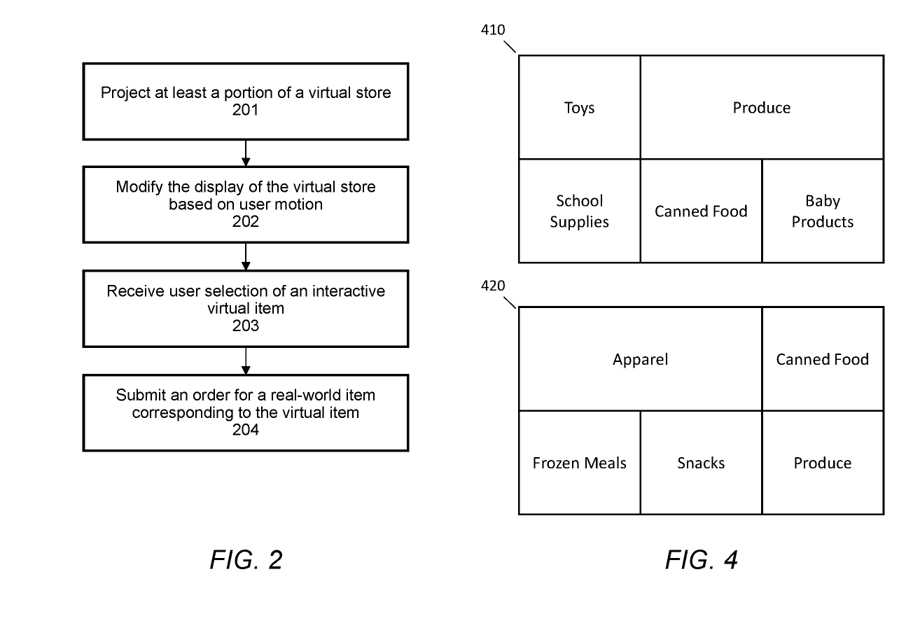

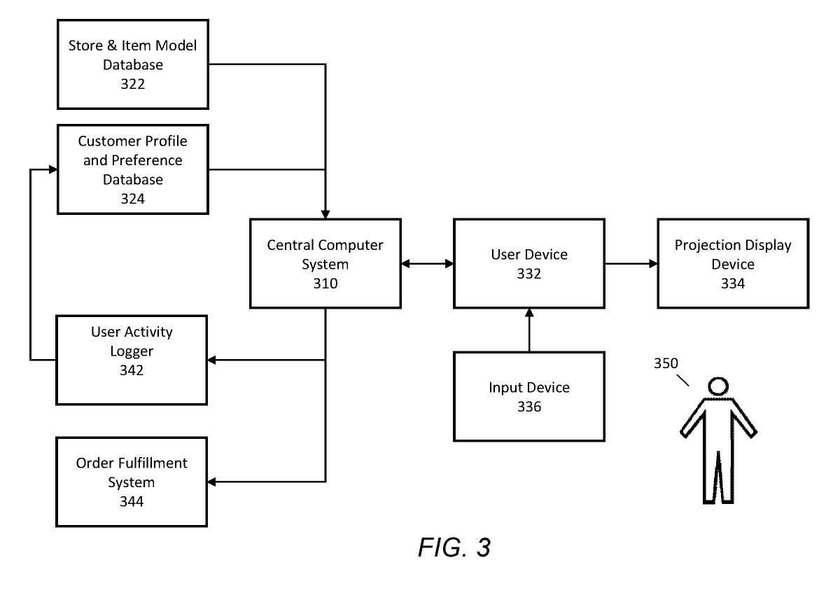

The control circuit 110 may comprise a central processing unit, a processor, a microprocessor and the like and may comprise one or more of a server, a central computing system, a retail computer system, a personal computer system, a gaming device, a home entertainment system, a mobile device, and the like. The control circuit 110 may be configured to execute computer readable instructions stored on a computer readable storage memory (not shown). The computer readable storage memory may comprise volatile and/or non-volatile memory and have stored upon it a set of computer readable instructions which, when executed by the control circuit 110, causes the system to provide a virtual shopping space via the projection display device 120 to the user 140 and detect user motions via the motion tracking device 130. Generally, the computer executable instructions may cause the control circuit 110 to perform one or more steps in the methods and processes described with reference to FIGS. 2-3 herein.

The projection display device 120 may generally be a display device that projects a display of a three dimensional (3D) virtual space into a physical space accessible by the user 140. The user's motions in the physical space may then be converted into motions in the projected virtual shopping space. In some embodiments, the projection display device may comprise one or more of a projector, a 3D mapping projector, an augmented reality display, a virtual reality display, a hologram display and the like. In some embodiments, the projection display device 120 may comprise one or more display units situated in a physical space. In some embodiments, the projection display device 120 may comprise a wearable device such as a head mounted display device. In some embodiments, the projection display device may display computer generated images that augments, overlays, partially obstructs, and/or fully obstructs the user's view of the physical space in front of the user. In some embodiments, the projection display device is configured to overlay an image of a product over the user's view of the physical space. For example, a display of furniture may overlay the customer's view of his/her living room. In another example, a display of a shirt may overlay the customer's view of himself/herself in a mirror. In some embodiments, the system may generate a virtual avatar of the user and overlay apparel and/or accessories on the virtual avatar to display to the user. In some embodiments, the projection display device may be configured to combine an image of a product over an image of the physical space around the user. In some embodiments, the projection display device may be configured to project images onto a physical object in the physical space such as a wall, furniture, a display surface, a canvas, etc. In some embodiments, the objects in the virtual space may be projected to real-life scale and the user's motions in the physical space may be translated to motions in the virtual space at scale. For example, if the user reaches forward for 5 inches in front of their eyes in the physical space, they also reach forward for 5 inches in the virtual space and may interact with virtual objects positioned 5 inches from their eyes in the virtual space.

The motion tracking device 130 may generally include one or more sensors configured to sense the motion of at least a part of a human body. In some embodiments, the motion tracking device 130 may comprise one or more of an image sensor, a gesture sensor, a light sensor, a range sensor, an eye tracker, a gyroscope, a wearable sensor, and the like. In some embodiments, the one or more sensors of the motion tracking device 130 may be stationary and/or wore on the user. Generally, the motion tracking device 130 is configured to detect the user's motion as input and provide that input to the control circuit 110. The control circuit 110 may then determine the content to the display on via the projection display device 120 based on the detected motion. In some embodiments, the detected motion may be used to determine the location and the perspective of the virtual store to render to the user. For example, when the user turns his/her head or walks forward in the physical space, the control circuit 110 may calculate the corresponding movement in the virtual space and modify the display of the virtual shopping space according to the user's physical movement. In some embodiments, the detected motion may be used to determine the user's interaction with the virtual world. For example, if the motion tracking device 130 detects that the user reaches out at a specific direction in the physical space, the control circuit 110 may determine the object in the virtual shopping space that corresponds to the location of the user's hand in the physical space and allow the user to manipulate the location and/or orientation of the virtual object with hand motion (e.g. pick up, turn around, etc.). In some embodiments, the detected motion may be used to determine a command from the user. For example, specific motions (e.g. swipe down, draw a circle, etc.) may be associated with action commands such as “add an item to basket” and “check out and pay.” In some embodiments, the projection display device 120 may display a menu for the user to select commands and options. In some embodiments, the virtual store may include a menu overlay display and the user motions may correspond to menu navigation and selections. In some embodiments, the system 100 may include other user input and out devices such as a speaker, a voice sensor, a hand held controller, a mobile device, and the like for receiving user input and interaction with the virtual store.

The projection display device 120 and the motion tracking device 130 may communicate with the control circuit 110 via one or more of a wired, wireless, and network connection. In some embodiments, the control circuit 110 may be implemented with one or more physical devices that are local, remote, networked, and/or cloud based. In some embodiments, the projection display device 120 may perform at least part of the graphics rendering for the virtual shopping space display. In some embodiments, functions of the control circuit 110 described herein may be performed by one or more of a local application, a server based application, and/or a cloud based application. In some embodiments, the projection display device 120 and the motion tracking device 130 may be implemented as part of a wearable display device such as a head mounted display. In some embodiments, the control circuit 110 further communicates with a central server to receive at least part of the information and data used to generate the display of the virtual shopping space. In some embodiments, the control circuit 110 communicates with a remote shipping and fulfillment system to submit orders the user 140 makes in the virtual shopping space.

Referring now to FIG. 2, a method of providing a virtual store is shown. In some embodiments, the steps shown in FIG. 2 may be performed by a processor-based device, such as the control circuit 110, executing a set of computer readable instructions and/or the central computer system 310 described with reference to FIG. 3 below.

In step 201, the system projects a least a portion of a virtual store into a physical space to a user. The virtual store may be projected with a projection display device such as the projection display device 120 described with reference to FIG. 1. In some embodiments, the virtual store may be projected via a head-mounted display, an augmented reality display, a holograph projector, a projection mapping display, etc. The physical space may be a customer's home, a virtual store booth, a virtual store access room, and the like. Generally, the physical space may be any space in which user's motions can be translated to motions in the virtual space projected into the physical space. The projection may be visible to one user or multiple users in the same space. The projected virtual store may include one or more of a plurality of interactive virtual items, virtual display shelves, in-store promotion displays, store decoration items, and selectable menu options. In some embodiments, the virtual store may be at least partially based on a 3D scan of a physical store space. The virtual items may correspond to real-world items offered for sale by a seller and may be configured to be manipulated with hand motions the user. For example, a section of the virtual store may correspond to canned foods section and the virtual items may represent various types and brands of canned foods that the seller offers to sell. The virtual display shelves may simulation shelves, cases, stands, etc. in physical stores such that users can view and interact with various items displayed on the shelves. The in-store promotion displays may comprise virtual banners, posters, signage, etc. In some embodiments, the promotion displays in the virtual store may be interactive. For example, a user may be able to select an item to review and/or purchase via a virtual banner or poster. The store decoration items may comprise aesthetic items that may not correspond to a real-world item offered for sale. Generally, the virtual store and the items in the virtual store may simulate a brick and mortar store experience with fixtures and items rendered to be displayed approximately at real-life scale. In some embodiments, the virtual store may include a floating menu display that the user can access anytime in the virtual space. For example, a user may cause a floating menu to be displayed with a specific gesture (e.g. swipe up, draw square, etc.) or voice command. The floating menu may include options such as preferences, help, search, and checkout. In some embodiments, one or more menu options may also be accessible through voice command and/or a handheld user device.

In some embodiments, only a portion of the virtual store is displayed at a time. For example, only a limited portion of the store that is visible from the user's perspective within the virtual space may be rendered and displayed. In some embodiments, the display portion may correspond to an aisle, a department, an area approximately the size of the physical space that the user is in, etc. The user may move about the virtual store either by walking, pointing, using a handheld controller, using voice command and the like, to see different portions of the store. When the user moves about the virtual space, different sections of the store may be displayed. In some embodiments, the user may “teleport” within the virtual store by issuing a command. For example, the user may select a department or item from a displayed menu and be moved to the selected department or item in the virtual store. In another example, the user may say “take me to vitamins” and be moved in front of the display shelves that display vitamins in the virtual store. In some embodiments, the user may call up a map of the virtual store and selection a destination using the map.

In some embodiments, the display of the virtual store may be customized to different customers. In some embodiments, an arrangement of the plurality of interactive virtual items, an arrangement of sections of the virtual store, a display of in-store promotions, a virtual store decoration, a virtual store color scheme, and a virtual store lighting may be customized based on a user profile. For example, if a customer selects a vegan preference the store may be customized to only display non-animal products. In another example, if a customer never buys anything from the hardware department, the hardware department may be removed from or rearranged to the edge of that user's customized virtual store. In another example, the items and/or sections may be arranged such that items that are often purchased by the customer are spatially prioritized for easy access by the user (e.g. brought closer to the front of the virtual store, displayed on an eye-level shelf, etc.). In yet another example, the virtual store's appearance, decoration, and in-store promotions may also be modified based on user's demographic, preference, and/or shopping history information.

In some embodiments, the virtual shopping space may comprise multiple areas that are each associated with different seller entities. For example, the virtual shopping space may simulate a shopping mall where separate spaces host different sellers and a customer may navigation from one seller's store to another in the virtual space via common space such as walkways, lobbies, atriums, etc. In some embodiments, stores may be leased to sellers who may determine what items to offer for sale, set prices for each item, and modify appearances of the leased space, etc. In some embodiments, the system may determine how to process an order based on the seller associated with the item selected by the user. In some embodiments, the user's selection may be directly communicated to the seller for the seller to process. In some embodiments, the system may centrally process payments and send the collected payment to the individual seller's account. In some embodiments, the selection and/or arrangement of the stores within the shopping mall may also be customized based on the user's customer profile.

In step 202, the system modifies the display of the virtual store based on the user's motion. User motion may be detected by a motion tracking device such as the motion tracking device 130 described with reference to FIG. 1. In some embodiments, user motion may be detected by one or more of an image sensor, a gesture sensor, a light sensor, a range sensor, an eye tracker, a gyroscope, a wearable sensor, and the like. In some embodiments, the detected motion may be used to determine the location and perspective of the virtual store to render to the user. For example, when the user turns their head or walks forward in the physical space, the system may calculate the corresponding movement in the virtual space and modify the display of the virtual shopping space according to the user's physical movement. In some embodiments, the detected motion may be used to determine the user's interaction with objects in the virtual world. For example, if the motion tracking device detects that the user reaches out at a specific direction in the physical space, the system may determine what object in the virtual shopping space corresponds to the location of the user's hand and allow the user to manipulate the virtual object with hand motion (e.g. pick up, turn around, etc.). In some embodiments, the detected motion may be used to determine a user command. For example, specific motions may be associated with the command of “add item to basket” and “check out and pay.” In some embodiments, the system may display a menu for the user to select commands and options. In some embodiments, the system may modify the display of the virtual store based on other types of user input such as voice command, hand held controller input, a mobile device input, and the like. For example, the user may say “take me to apparel” and the system may change the displayed section of the virtual store to the apparel section. In some embodiments, the user may be offered the option to “try on” an item. If the user elects to try on an item, the system may project a visual representation of the item at scale either into the user's physical environment or onto an avatar of the user.

In step 203, the system receives a user selection of an interactive virtual item in the virtual store. The user selection of a virtual item may be received through a motion tracking device and/or through another user input device. For example, the user may motion to pick an item off a virtual shelf and say “add to basket” to select an item. In another example, when a user selects an item by either touching it, picking it up, and/or pointing to it in the virtual store, the user may be presented with a menu of options such as “more information,” “add to basket,” “purchase now,” etc.

In step 204, the system submits an order for one or more real-world items corresponding to the virtual item(s) selected in step 203. The order may be submitted to a shipment and fulfillment system of the seller. For example, if the user picks up a virtual item representation of an A-Brand cereal and selects to “purchase now,” the system may then submit an order for a real-world A-Brand cereal to be shipped to the user. In some embodiments, the system may use previously stored methods of payment and/or delivery methods for the order in step 204. In some embodiments, the user may be prompted to provide or verify a method of payment and/or delivery method (e.g. pick up location and/or shipping address) prior to step 204. In some embodiments, the order may be transmitted via a network such as the Internet to the seller's ordering and shipping system.

After step 204, the shipment and fulfillment system may package and deliver the item(s) to the customer. In some embodiments, the user may continue to navigate through the virtual store to make additional purchases. In some embodiments, user's movements within the virtual store, interactions with virtual objects, and purchase histories may be recorded by the system. The recorded information may be used to improve shopper experience for all users and/or may be added to individual user's profile to customize the user's future virtual store experience. For example, if a user shows a preference for a certain brand of products, the virtual store's layout may be modified to more prominently feature that brand of products. The system may also select promotional offers to provide to the customer based on the user's activity in the virtual store.

Referring now to FIG. 3, a block diagram of an overall system for providing a virtual shopping space is shown. The system includes a central computer system 310, a store and item model database 322, a customer profile and preference database 324, a user device 332, an input device 336, a projection display device 334, a user activity logger 342, and an order fulfillment system 344.

In some embodiments, the user device 332, the projection display device 334, and the input device 336 may be situated in the same physical space as the user 350. For example, the user 350 may access a virtual store at their own residence, in a virtual store booth, at a virtual store access location, etc. The user device 332 may be owned by the user 350 or be owned and operated by the seller or a third party. For example, a user may enter a virtual store experience booth with the projection display device 334 setup that allows the user to navigate various parts of a large virtual store in the limited physical space of the booth. In some embodiments, the virtual store may be projected at any location of the user's choosing with a portable the user device 332. A user 350 may initiate the display of the virtual store using the input device 336 which may comprise one or more of a motion tracking device, a voice receiver, a touch sensor, a controller, a mobile device, and the like. In some embodiments, the input device 336 comprises a motion sensor which triggers the display of the virtual store upon detecting the presence of the user.

The central computer system 310 and/or the user device 332 may determine the content of the virtual store to display to the user. The central computer system 310 may configure the virtual store based on information in a customer profile and preference database 324. For example, the central computer system 310 may determine items and/or categories of items that the user are more likely to be interested in purchasing and place those items closer to the user in the layout of the virtual store. In another example, the central computer system 310 may determine certain items that the user is unlikely to be interested in, and remove those items from the layout of the virtual store. In some embodiments, the central computer system 310 may also configure the color scheme, decor, lighting, and promotional displays of the virtual store based on the customer's profile. The customer's profile may include information such as a user demographic, a user shopping history, a user-entered preference, and a user address. In some embodiments, the customer may manually enter their preferences (e.g. “organic food,” “toys only,” etc.).

After determining the parameters and configurations of the virtual store, the central computer system 310 retrieves the associated store and item models from the store and item model database 322. The store and item model database 322 may contain various store layout models, display shelf models, and/or 3D models of individual items offered for sale. The 3D models of items offered for sale may be a computer aided design (“CAD”) model and/or a 3D scan of the actual item. The store layout models may include different types of display cases, shelves, and fixtures, different decoration and/or color schemes, etc. The store layout models may further include a floor plan and layout templates for stores and sections of a store. The models and layouts may be provided to the user device 332 to be rendered for projection display and/or may be at least partially rendered at the central computer system 310.

The projection display device 334 is configured to display a 3D projection of a virtual store provided by the user device 332 and at least partially based on information received from the central computer system 310. The input device 336 may detect user's movements and commands. The input device 336 may include motion trackers used by the user device 332 to determine the perspective and/or content of the virtual store to render to the user. For example, the input device 336 may render different views of a section of the store when the input device 336 detects that the user 350 has turned his head. The input device 336 may detect other user inputs such as voice, touch, and gesture inputs.

The various user actions detected by the input device 336 may be recorded at the user activity logger 342. For example, user activity logger 342 may log the duration the user 350 spends in each section of the store, the duration the user 350 spends looking at a specific section of a display shelf or an item, the virtual items the user picks up to examine, and the virtual items that the user places in the virtual basket, etc. The user activity logger 342 may also store the virtual store parameters (e.g. store layout, item layout, promotion displays, color scheme, etc.) associated with the recorded user's activities. The logged information may be parsed and added to the customer profile and preference database 324 and/or be used to improve the user experience for multiple users. For example, if the user activity logger 342 indicates that the user is more likely to make purchases with a specific store color scheme and/or lighting condition, the customer profile and preference database 324 may store this preference for future use. In another example, if the user activity logger 342 indicates the customer may be interested in a new product that he/she had never purchased before, the system may prioritize the display of those items for future virtual store configurations for that user to promote those items. In some embodiments, the user activity may be used to generate purchase recommendations and advice via a virtual personal shopping assistant in the virtual shopping space. In some embodiments, the customer profile and preference database 324 may also include customer information gathered and provided by third parties.

In the virtual store environment, the user may select one or more items for purchase via the input device 336. For example, the user may place an item in a virtual basket with motion and/or make a voice command to purchase an item (e.g. holding the item and saying “buy this”). The user device 332 may relay the purchase command to the central computer system 310 which then places an order for the corresponding real-world item with the order fulfillment system 344. In some embodiments, the central computer system 310 may use payment and delivery information stored in the customer profile for the order. The order fulfillment system 344 receiving the order may process the payment and ships the item to the user 350 similar to other types of online orders.

Referring now to FIG. 4, an illustration of customized virtual store layouts are shown. In FIG. 4, the first layout 410 may be a customized virtual store layout for a first customer and the second layout 420 may be a customized virtual store layout for a second customer. In the first layout 410, store sections for toys, produce, school supplies, canned food, and baby products are included in the virtual store. In the second layout 420, store sections for apparel, canned food, frozen meals, snacks, and produce are included in the virtual store. These sections may be selected based on a user profile including information relating to one or more of user-entered preference, user's demographic, and shopping history information. The arrangement of the sections may also be determined based on the user profile. For example, the sections may be arranged in an order that the user typically picks up various items in the store. In some embodiments, the size of each section may also be customized for the customer. For example, the produce section may be smaller for the second user than for the first user because the second user only purchases a limited range of items (e.g. fruits, but never vegetables). The location at which the user enters the store may also be customized. For example, the user may be first dropped into a section that he/she most frequency purchases from each time the user enters the store.

The layout of the virtual store generally affects how the user navigates through the virtual space. For example, in the first layout, if the user exits the toys section to the right, the user will enter the produce section. The sections may be arranged in a way as to effectively bring items that may be of interest to the user to his/her attention as he/she moves about the virtual store. In some embodiments, the user may be permitted to design their own store layout by arranging the sections. In some embodiments, users can specifically request a section of the store that is not currently part of the virtual store layout, and the virtual store may connect the requested section to the existing layout. For example, in the first layout 410, if the user requests the frozen meals section, the frozen meals section may be connected via a new pathway from the canned food section. In some embodiments, the user may request to be “teleported” to a specific section and/or item with either menu sections and/or voice command (e.g. “take me to toothbrushes”).

The virtual store layouts shown in FIG. 4 are provided as examples only. A virtual store may include more or fewer sections of any shape and size and may mix items from different sections in the same area. In some embodiments, each section may represent a different seller's store. For example, the virtual shopping space may simulate a shopping mall where separate spaces host different sellers and a customer may navigation from one seller's store to another Individual virtual item may also be selected for display and arranged in a similar manner.

With the systems, methods, and apparatus described herein, an in-store experience may be provided to a customer at any location with a projection display device. A user may shop in the familiar environment of a brick and mortar store through virtual simulation while enjoying various conveniences offered by the immersive virtual environment. The stores may further be custom tailored to each customer's preferences and needs.

In one embodiment, a system for providing a virtual shopping space comprises a projection display device, a motion tracking device, a control circuit coupled to the projection display device and the motion tracking device. The control circuit is configured to: cause the projection display device to project at least a portion of a virtual store into a physical space to a user, the virtual store comprising a plurality of interactive virtual items, modify the display of the at least the portion of the virtual store based on user motion detected by the motion tracking device, receive a user selection of an interactive virtual item in the virtual store, and submit, to an order fulfillment and shipment system, a purchase order for a real-world item, corresponding to the selected interactive virtual item in the virtual store.

In one embodiment, a method for providing a virtual shopping space comprises: causing a projection display device to project at least a portion of a virtual store into a physical space to a user, the virtual store comprises a plurality of interactive virtual items, modifying the display of the at least a portion of the virtual store based on user motion detected by a motion tracking device, receiving a user selection of an interactive virtual item in the virtual store, and submit, to an order fulfillment and shipment system, a purchase order for a real-world item, corresponding to the selected interactive virtual item in the virtual store.

In one embodiment, an apparatus for providing a virtual shopping space comprises a non-transitory storage medium storing a set of computer readable instructions and a control circuit configured to execute the set of computer readable instructions which causes to the control circuit to: cause a projection display device to project at least a portion of a virtual store into a physical space to a user, the virtual store comprises a plurality of interactive virtual items, modify the display of the at least a portion of the virtual store based on user motion detected by the motion tracking device, receive a user selection of an interactive virtual item in the virtual store, and submit a purchase order for a real-world item, corresponding the selected interactive virtual item in the virtual store, to an order fulfillment and shipment system.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for providing a virtual shopping space comprising:
a projection display device;
a motion tracking device;
a control circuit coupled to the projection display device and the motion tracking device, wherein the control circuit is configured to:
cause the projection display device to project at least a portion of a virtual store into a physical space to a user, the virtual store comprising a plurality of interactive virtual items;
modify the display of the at least the portion of the virtual store based on user motion detected by the motion tracking device;
receive a user selection of an interactive virtual item in the virtual store; and
submit, to an order fulfillment and shipment system, a purchase order for a real-world item, corresponding to the selected interactive virtual item in the virtual store.

2. The system of claim 1, wherein the control circuit is further configured to:
customize the display of the at least a portion of the virtual store based on a user profile associated with the user.

3. The system of claim 2, wherein the user profile comprises one or more of: a user demographic, a user shopping history, a user-entered preference, and a user address.

4. The system of claim 2, wherein one or more of an arrangement of the plurality of interactive virtual items, an arrangement of sections of the virtual store, a display of in-store promotions, a virtual store decoration, a virtual store color scheme, and a virtual store lighting, are customized based on the user profile.

5. The system of claim 1, wherein actions of the user in the virtual store are recorded and added to a user profile.

6. The system of claim 1, wherein the projection display device comprises one or more of: a head-mounted display, an augmented reality display, a holograph projector, and a projection mapping display.

7. The system of claim 1, further comprising: a voice sensor coupled to the control circuit, wherein the control circuit is further configured to receive a user command based on voice recognition.

8. The system of claim 1, wherein a display and an orientation of each of the plurality of interactive virtual items is configured to be manipulated with hand motions the user tracked by the motion tracking device.

9. The system of claim 1, wherein one or more of the plurality of interactive virtual items are projected on to a physical object in the physical space.

10. The system of claim 1, wherein the control circuit is further configured to:
process a payment for the user for the purchase order.

11. The system of claim 1, wherein the virtual store comprises a plurality of sections each comprising interactive virtual items offered for sale by different sellers, and the control circuit is configured to submit the purchase order based on an identity of the seller associated with the selected interactive virtual item.

12. A method for providing a virtual shopping space comprising:
causing a projection display device to project at least a portion of a virtual store into a physical space to a user, the virtual store comprises a plurality of interactive virtual items;
modifying the display of the at least a portion of the virtual store based on user motion detected by a motion tracking device;
receiving a user selection of an interactive virtual item in the virtual store; and
submit, to an order fulfillment and shipment system, a purchase order for a real-world item, corresponding to the selected interactive virtual item in the virtual store.

13. The method of claim 12, further comprising:
customizing the display of the at least a portion of the virtual store based on a user profile associated with the user.

14. The method of claim 13, wherein the user profile comprises one or more of: user demographic, user shopping history, user-entered preference, and user address.

15. The method of claim 13, wherein one or more of an arrangement of the plurality of interactive virtual items, an arrangement of sections of the virtual store, a display of in-store promotions, a virtual store decoration, a virtual store color scheme, and a virtual store lighting, are customized based on the user profile.

16. The method of claim 12, wherein actions of the user in the virtual store are recorded and added to a user profile.

17. The method of claim 12, wherein the projection display device comprises one or more of: a head-mounted display, an augmented reality display, a holograph projector, and a projection mapping display.

18. The method of claim 12, further comprising:
receiving a user command, via a voice sensor, based on voice recognition.

19. The method of claim 12, wherein a display and an orientation of each of the plurality of interactive virtual items is configured to be manipulated with hand motions of the user tracked by the motion tracking device.

20. The method of claim 12, wherein one or more of the plurality of interactive virtual items are projected on to a physical object in the physical space.

21. The method of claim 12, further comprising:
processing a payment for the user for the purchase order.

22. The method of claim 12, wherein the virtual store comprises a plurality of sections each comprising interactive virtual items offered for sale by different sellers, and the purchase order is configured based on an identity of the seller associated with the selected interactive virtual item.

23. An apparatus for providing a virtual shopping space comprising:
a non-transitory storage medium storing a set of computer readable instructions; and
a control circuit configured to execute the set of computer readable instructions which causes to the control circuit to:
cause a projection display device to project at least a portion of a virtual store into a physical space to a user, the virtual store comprises a plurality of interactive virtual items;
modify the display of the at least a portion of the virtual store based on user motion detected by a motion tracking device;
receive a user selection of an interactive virtual item in the virtual store; and
submit a purchase order for a real-world item, corresponding the selected interactive virtual item in the virtual store, to an order fulfillment and shipment system.
